(19) United States
(12) Patent Application Publication
(10) Pub. No.: US 2025/0217556 A1
(43) Pub. Date: Jul. 3, 2025

(54) POWER GRID SIMULATION WITH REDUCED COMPONENT MODELS

(71) Applicant: X Development LLC, Mountain View, CA (US)

(72) Inventors: Leo Francis Casey, San Francisco, CA (US); Mike Miao He, Mountain View, CA (US); Hamed Khalilinia, San Mateo, CA (US); Raymond Daly, Palo Alto, CA (US)

(21) Appl. No.: 18/999,158

(22) Filed: Dec. 23, 2024

Related U.S. Application Data
(60) Provisional application No. 63/615,646, filed on Dec. 28, 2023.

(51) Int. Cl. G06F 30/27; G06F 113/04; G06F 119/06

(52) U.S. Cl. CPC G06F 30/27; G06F 2113/04; G06F 2119/06

(57) ABSTRACT

Methods, systems, and apparatus, including medium-encoded computer program products that perform operations that include obtaining one or more physical parameters and one or more predetermined operating conditions for a component to be connected to the electric power grid at a predetermined grid connection point. And, obtaining training data characterizing the component; generating, based on the obtained training data, physical parameters and one or more predetermined operating conditions, a reduced order simulator of the component, where the reduced order model is trained to simulate the behavior of the component at the predetermined connection point under the predetermined operating conditions.

### CROSS-REFERENCE TO RELATED APPLICATION

This application claims the benefit under 35 U.S.C. § 119 (e) of U.S. Patent Application No. 63/615,646, entitled “Power Grid Simulation With Reduced Component Models,” filed Dec. 28, 2023, which is incorporated herein by reference in its entirety.

### BACKGROUND

This specification relates to power grid simulations. This specification also relates to power grid simulations using reduced models of electrical components.

### SUMMARY

This specification describes technologies relating to power grid simulations. This specification also describes technologies relating to power grid simulations using reduced models of electrical components.

In general, one or more aspects of the subject matter described in this specification can be embodied in one or more methods that include the actions of obtaining one or more physical parameters and one or more predetermined operating conditions for a component to be connected to an electric power grid at a predetermined grid connection point; obtaining training data characterizing the component; and generating, based on the obtained training data, physical parameters, and the one or more predetermined operating conditions, a reduced order simulator of the component, where the reduced order model is trained to simulate the behavior of the component at the predetermined connection point under the predetermined operating conditions. Other implementations of this aspect include corresponding systems, apparatus, and computer programs, configured to perform the actions of the methods, encoded on computer storage devices.

In some implementations, obtaining training data characterizing the component can include obtaining real transient field data characterizing the electric transient response of the component.

In some implementations, obtaining training data characterizing the component can include obtaining synthetic transient data characterizing the electric response of the component for the one or more predetermined operating conditions.

In some implementations, obtaining training data characterizing the component can include obtaining empirical data characterizing the electric response of the component from a testbed for the one or more predetermined operating conditions.

In some implementations, obtaining training data characterizing the component can include obtaining empirical data characterizing the electric response of the component from a testbed with a hardware in the loop simulator for the one or more predetermined operating conditions

In some implementations, the reduced order model can be based on a neural network model.

In some implementations, the neural network model can be a physics-informed neural network model.

In some implementations, the neural network model can be based on a generative adversarial network.

One or more aspects of the subject matter described in this specification can be embodied in one or more methods that include the actions of: obtaining a transient simulator of an electric power grid including one or more predetermined grid connection points; obtaining a trained reduced order model of a first component for predetermined operating conditions; coupling the trained reduced order model of the first component to the transient simulator of the electric power grid at a first predetermined grid connection point of the one or more predetermined grid connection points; and simulating, based on the coupling, a behavior of the first component when connected to the electric power grid at the first predetermined grid connection point. Other implementations of this aspect include corresponding systems, apparatus, and computer programs, configured to perform the actions of the methods, encoded on computer storage devices.

In some implementations, the trained reduced order model can be based on a neural network model.

In some implementations, the trained neural network model can be a physics-informed neural network model.

In some implementations, the trained neural network model can be based on a generative adversarial network.

In some implementations, a trained model of a second component for predetermined operating conditions can be obtained. Coupling the trained model of the first component to the transient simulator of the electric power grid at a first predetermined grid connection point of the one or more predetermined grid connection points can include coupling the trained model of the first component to the trained model of the second component at the first predetermined grid connection point.

In some implementations, the operations can include predicting the electrical response of the first component at the first predetermined grid connection point for a predetermined time range and determining, based on the predicted electrical response, controlling instructions for the first component.

### BRIEF DESCRIPTION OF THE DRAWINGS

FIG. 1A shows an example of a system for performing power grid simulation using reduced component models.

FIG. 1B shows an example of an electric grid model generated using reduced component models.

FIG. 2 is a flowchart of an example of a process for training a reduced model of a component.

FIG. 3 is a flowchart of an example of a process for using the reduced model in a power grid simulation.

FIG. 4 is a schematic diagram of a data processing system including a data processing apparatus, which can be programmed as a client or as a server, and implement the techniques described in this document.

Like reference numbers and designations in the various drawings indicate like elements.

### DETAILED DESCRIPTION

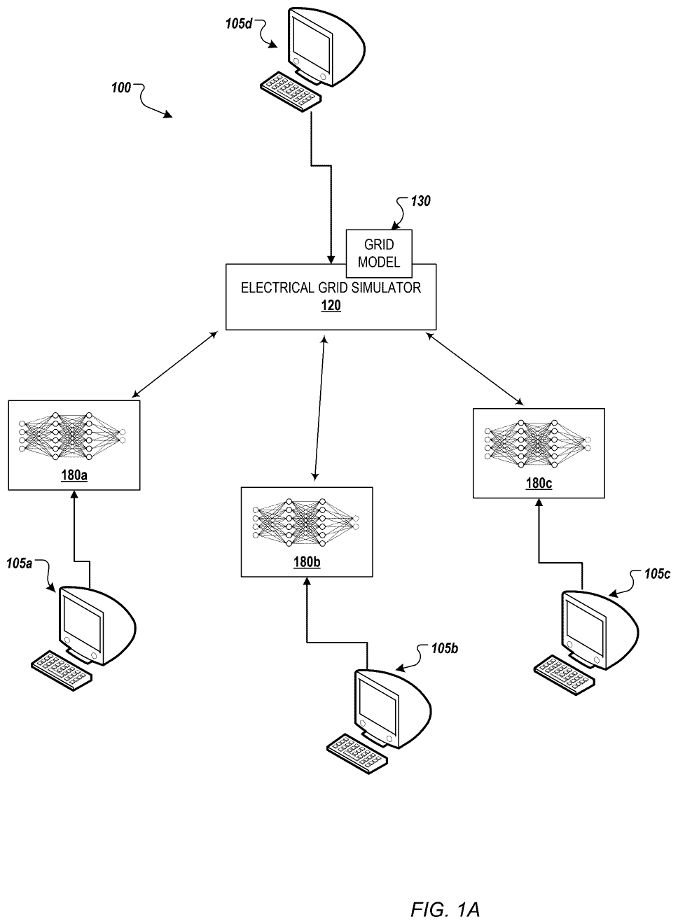

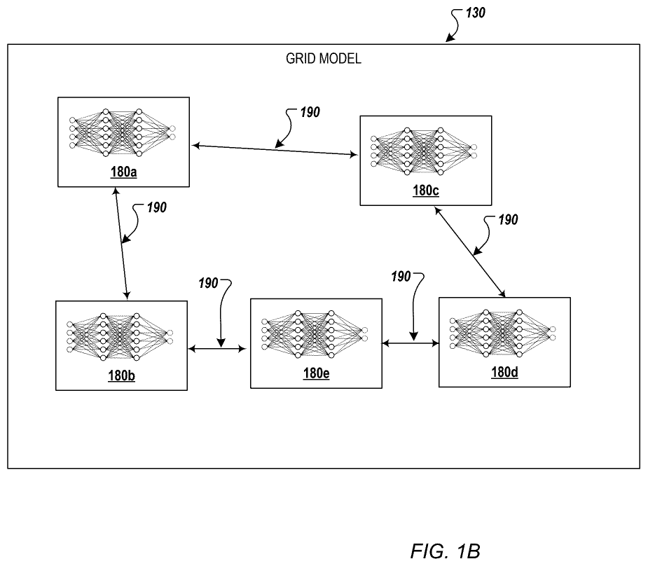

FIG. 1A shows an example of a system 100 for performing power grid simulation using reduced component models. The system 100 can include an electrical grid simulator 120 including a grid model 130 and one or more client devices 105a, 105b, 105c, 105d (collectively referred to as 105).

Electrical grid simulator 120 can be a cloud-based simulator. Simulator 120 can be a transient grid simulator. Electrical grid simulator 120 can use a model 130 of an electrical grid. The electrical grid model 130 can be accessed via a client device 105a, 105b, 105c, 105d. An Application Programming Interface (API) can allow users of the system 100 to provide a grid model 130 or a location of the model. In some implementations, the API can accept Uniform Resource Indicators (URIs) that specify the location to retrieve a grid model 130. The grid model 130 can be stored and accessed by electrical grid simulator 120 from a database. For example, a common model 130 of an electric grid can be used for many users of the system 110. For example, a common electrical grid model of a particular geographic region (e.g., California) can be accessed by users wishing to simulate the behavior of different physical hardware assets connected the electric grid in that particular geographic region.

A grid model 130 can include a plurality of models for individual assets or components connected to the electric power grid and a description of interconnections among the assets. A grid model 130 of an electric power grid can be represented as a graph. Nodes of the graph can represent assets, and each node can include information about the asset such as an identifier, the type of asset, the make and version of the asset, the date of installation, information about service performed on the asset, etc. Edges in the graph can represent connections among assets, and can include an indication of the direction of the flow of power. Each asset model can be configured to replicate operation of a corresponding type of physical electric grid asset, and each asset model can be used to simulate the operation of an asset or a type of asset.

Electrical systems include a broad range of interconnected components of various types such as inverters (Solar, Wind, high-voltage DC (HVDC), flexible AC transmission system (FACTS), etc.), relays, Power Plant Controllers (PPCs), Energy Management Systems, Remedial Action Systems (RAS), Automatic Generator Controls, alarm systems, among others. The operation of one component can influence the operation of other components. For example, a PPC regulates and controls networked inverters within a power plant.

Providing an accurate model of the behavior of each component connected to an electrical grid is a complex task. In some cases, component models are proprietary and not generally available. Further, transient simulations of the electrical grid are computationally demanding. Taking into account the detailed dynamic behavior of each component and its effect on other connected components of the electrical grid is computationally challenging. Also, when a change is planned for one component, the model of the component has to be updated accordingly so that the effect of this change in other connected components can be evaluated.

An electrical grid simulator can make use of reduced models of components. Reduced models are reduced parameter machine learning (AI) models trained to simulate the behavior of a particular type of electrical grid component or collection of components. Reduced models 180a, 180b, 180c can provide an approximation of the behavior of respective component connected to the electrical grid. Reduced models 180a, 180b, 180c can be trained to reproduce the behavior of a component connected to the electrical grid under different operating conditions. Sensor data can be used as input data for training reduced models 180a, 180b, 180c to predict the state of their corresponding components under different operating conditions. In some examples, client devices 105a, 105b, 105c can access reduced models 180a, 180b, 180c and/or provide the reduced models for use in grid model 130 with electrical grid simulator 120.

One or more pre-trained reduced models can be imported to or accessed by electrical grid simulator 120 and imported into an electrical simulation. Pre-trained reduced models can be object-oriented models. Precompiled versions of the reduced models can be stored in a library. The pre-trained models can be imported to or accessed by electrical grid simulator 120 to build an electrical grid simulation as a collection of precompiled pre-trained models of the different assets or components of a predetermined region of the electrical grid. The pre-trained models can be interconnected to reproduce the grid topology and the electrical responses of their corresponding physical real-world components in the presence of the rest of the components present in the electrical grid model.

FIG. 1B shows an example of an electric grid model 130 generated using reduced component models. For example, one or more electrical components are represented by a reduced model 180. Each reduced model 180 is trained to receive input values representing electrical properties (e.g., current, voltage, phase) that would be input to the particular type of electrical component that the model 180 is trained to simulate, and to produce an output that simulates the operation of the electrical component in response to the applied inputs.

For example, reduced model 180a may represent a gas turbine generator, reduced model 180b may represent an electrical substation, reduced model 180c may represent an industrial power load (e.g., a factory), reduced model 180d may represent a residential load (e.g., a neighborhood), and reduced model 180e may represent a renewable power source (e.g., a solar power farm and associated inverters/power storage).

Each reduced model 180a-180e is trained to simulate the operation of the particular type of electrical asset. For example, reduced model 180e can be configured to receive input vectors defining solar load over a period of time, electrical line voltages

Edges 190 represent electrical connections between the reduced models 180. In the model 130, each edge represents a transfer of data between connected reduced models 130. For example, output values from the gas turbine generator model 180a (e.g., power, voltage, current, phase) will be communicated as input vectors to the industrial power load model 180c and the substation model 180b. Values representing load demand can be transferred back from models 180b, 108c to the gas turbine generator model 180a. Each edge may have an associated electrical impedance used to scale the values transferred between reduced models.

The electric grid simulator 120 can simulate operations of an electric grid, or portion thereof, by executing the simulation on model 130 of the grid constructed of interlinked reduced models 180. For example, the electric grid simulator 120 can apply initial simulation conditions as input the to one or more of the reduced models 180. The electric grid simulator 120 can generate simulation output based on the interactions and outputs generated by each reduced model 180.

In some implementations, the electric grid model 130 can be a hybrid model that models some electrical components using the reduced models 180 and other components as a more traditional mathematical model (e.g., a set of equations or non-trainable software code such as an object class). For example, more complex components such as generators, inverters, substations, etc. can be represented using the reduced models 180 while les complex components such as wires and transformers can be represented using traditional mathematical models of those components.

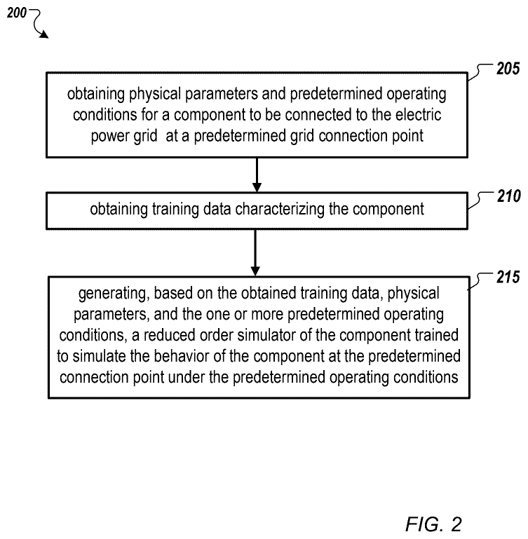

FIG. 2 is a flowchart of an example of a process 200 for training a reduced model of an electrical component.

At 205, one or more physical parameters and one or more predetermined operating conditions for a component to be connected to an electric power grid at a predetermined grid connection point can be obtained. The component can be any asset or electrical component that can be connected to an electric power grid.

In some examples, the electrical component can include a broad range of interconnected components of various types such as inverters (Solar, Wind, high-voltage DC (HVDC), flexible AC transmission system (FACTS), etc.), relays, Power Plant Controllers (PPCs), Energy Management Systems, Remedial Action Systems (RAS), Automatic Generator Controls, alarm systems, among others.

The one or more physical parameters are parameters that determine the available operating range and/or behavior of the component during operation. For example, physical parameters of an inverter can include: a power rating, a voltage input range, a conversion efficiency, a temperature range, among others.

The one or more operating conditions characterize conditions to which the electrical component is subject at least at a certain point or points in time. For example, the operating conditions can include an input voltage, a temperature, a humidity, and other environmental conditions such as solar irradiance, among others.

At 210, training data characterizing the component can be obtained. Obtaining training data characterizing the component can include obtaining real field data characterizing the electric response of the component under a variety of operating conditions. In some examples, data characterizing a steady state of the component can be gathered using one or more sensors. These data can be used to characterize the response of the electrical component under stable operating conditions such as a constant load and power supply. For example, historical load profiles can be gathered using one or more sensors.

In some examples, data characterizing the transient electric response of the component can also be gathered using one or more sensors. These data can be used to characterize the response of the electrical component under sudden changes in load and/or power supply, faults, environmental changes, among others. For example, historical load profiles can be gathered using one or more sensors.

Obtaining training data characterizing the component can include obtaining synthetic transient data characterizing the electric response of the component for the one or more predetermined operating conditions. For example, the electric response of the component can be obtained using a simulation of the operation of the component for the one or more predetermined operating conditions. Obtaining training data characterizing the component can include obtaining empirical data characterizing the electric response of the component from a testbed for the one or more predetermined operating conditions. In some examples, a hardware in the loop simulator can be used for the one or more predetermined operating conditions.

At 215, a reduced order simulator of the component can be generated, based on the obtained training data, physical parameters, and the one or more predetermined operating conditions. The reduced order model can be trained to simulate the behavior of the component at the predetermined connection point under the predetermined operating conditions.

In some examples, the reduced model can be based on a neural network model. In some examples, the neural network model can be based on a generative adversarial network. Reduced models based on generative adversarial networks can generate data with the same statistics as the training data used to train the reduced order model.

In some examples, the neural network model can be based on a physics-informed neural network. Physics-informed neural networks can embed knowledge of the physical laws that govern a given data set in the learning process, and can be described by partial differential equations. Using a neural network model based on a physics-informed neural network can overcome low data availability to be used as training data.

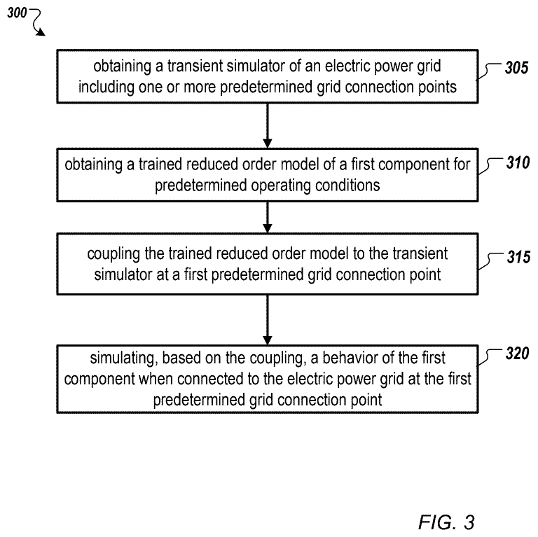

FIG. 3 is a flowchart of an example of a process 300 for using the reduced model in a power grid simulation. In some examples, the power grid simulation can be a power grid simulation performed using a simulator such as electrical grid simulator 120. For example, the reduced model can correspond to one or more of the reduced models 180a, 180b, 180c used to perform a power grid simulation using electrical grid simulator 120 and grid model 130 in FIG. 1.

At 305, a simulator of an electric power grid including one or more predetermined grid connection points can be obtained. In some examples, the simulator can be a transient power grid simulator that can capture transient changes using a grid model, such as grid model 130. The grid model includes nodes that represent components in the grid. The grid model also includes edges representing connections among components, and can include an indication of the direction of the flow of power. In order to execute a power grid simulation, a component model at each node of a region of interest of the grid can be configured to replicate operation of a corresponding electrical component.

At 310, a trained model of a first component for predetermined operating conditions can be obtained. For example, the trained model can be a reduced model generated using the method of FIG. 2. As described in more detail above with reference to FIG. 2, the trained model can be based on a neural network model. The trained neural network model can be based on a generative adversarial network. In some examples, the trained neural network model can be a physics-informed neural network model.

At 315, the trained model of the first component can be coupled to the transient simulator of the electric power grid at a first predetermined grid connection point of the one or more predetermined grid connection points. An output of the pre-trained model of the component can be fed into the transient simulator of the electric power grid at the first predetermined grid connection point to simulate the impact of component on the overall grid behavior or the area of interest of the grid under simulation.

For example, the component can be an inverter in a solar installation. The pre-trained model of the inverter reproduces the operation of the inverter converting DC power from solar panels into AC power that can be fed into the grid. For example, a predicted inverter AC power output can be fed into the transient simulator to simulate the impact of the solar installation on the area of interest of the grid.

Pre-trained models of electrical components can be imported from a library or accessed by the simulator to build an electrical grid simulation as a collection of pre-trained models of the different components in the region of interest of the grid. The pre-trained models can be interconnected to reproduce the grid topology and the electrical responses of their corresponding components in the presence of the rest of the components in the region of interest. For example, a trained model of a second component can be obtained. Coupling the trained model of the first component to the transient simulator of the electrical power grid can include coupling the first component and the second component at the first predetermined grid connection point.

At 320, a behavior of the first component when connected to the electric power grid at the first predetermined grid connection point can be simulated based on the coupling. For example, the electrical response of the first component at the first predetermined grid connection point can be predicted for a predetermined time range. For example, transient responses of the component under changes in operating conditions can be predicted. For example, sensing data, such as meteorological data or other environmental data reflecting current conditions in the area of interest of the electrical grid can be obtained and input to the simulator to predict the behavior of the first component or a plurality of electrical components for a predetermined time range.

Grid simulation using reduced models as described show enhanced parallelization capabilities and can reduce the computational cost of transient grid simulation. In some examples, the results of the grid simulation can be used in electrical grid operation planning and electrical grid management. In some examples, the predicted electrical response of the first component at the first predetermined grid connection point for a predetermined time range can be used to determine, based on the predicted electrical response, controlling instructions for the first component.

The simulator can build an electrical grid simulation as a collection of a plurality of pre-trained models of a plurality of electrical components that are coupled in a region of interest of the grid at their respective connection points. The electrical responses of the corresponding plurality of components can be simulated, for example based on real-time sensing data, to generate controlling instructions for the plurality of electrical components to optimize grid operations.

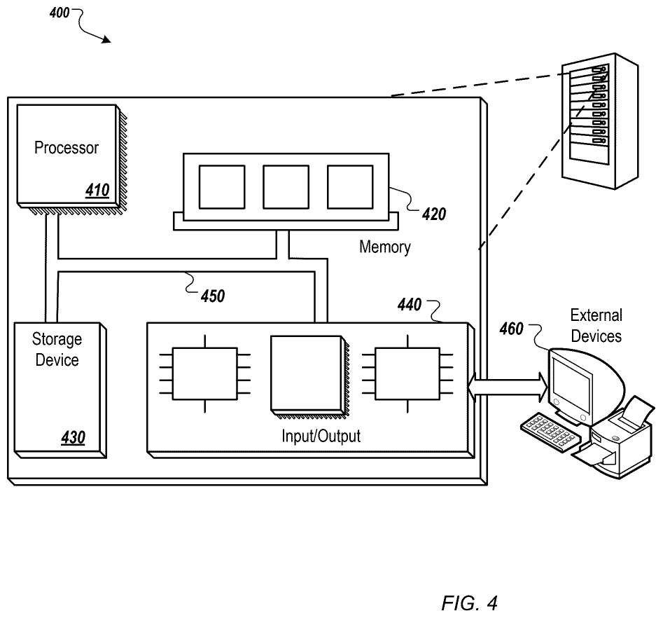

FIG. 4 is a block diagram of an example computer system 400, which can be used to implement the techniques described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
obtaining one or more physical parameters and one or more predetermined operating conditions for a component to be connected to an electric power grid at a predetermined grid connection point;
obtaining training data characterizing the component; and
generating, based on the obtained training data, physical parameters, and the one or more predetermined operating conditions, a reduced order simulator of the component, wherein the reduced order model is trained to simulate operational behavior of the component at the predetermined connection point under the predetermined operating conditions.

2. The method of claim 1, wherein obtaining training data characterizing the component comprises obtaining real transient field data characterizing an electrical transient response of the component.

3. The method of claim 1, wherein obtaining training data characterizing the component comprises obtaining synthetic transient data characterizing an electrical response of the component for the one or more predetermined operating conditions.

4. The method of claim 1, wherein obtaining training data characterizing the component comprises obtaining empirical data characterizing an electrical response of the component from a testbed for the one or more predetermined operating conditions.

5. The method of claim 1, wherein obtaining training data characterizing the component comprises obtaining empirical data characterizing an electrical response of the component from a testbed with a hardware in the loop simulator for the one or more predetermined operating conditions.

6. The method of claim 1, wherein the reduced order model is based on a neural network model.

7. The method of claim 6, wherein the neural network model is a physics-informed neural network model.

8. The method of claim 7, wherein the neural network model is based on a generative adversarial network.

9. A computer-implemented method comprising:
obtaining a transient simulator of an electric power grid comprising one or more predetermined grid connection points;
obtaining a trained model of a first component for predetermined operating conditions;
coupling the trained model of the first component to the transient simulator of the electric power grid at a first predetermined grid connection point of the one or more predetermined grid connection points; and
simulating, based on the coupling, a behavior of the first component when connected to the electric power grid at the first predetermined grid connection point.

10. The method of claim 9, wherein the trained model is based on a neural network model.

11. The method of claim 10, wherein the neural network model is a physics-informed neural network model.

12. The method of claim 10, wherein the neural network model is based on a generative adversarial network.

13. The method of claim 9, comprising:
obtaining a trained model of a second component for predetermined operating conditions; and
wherein coupling the trained model of the first component to the transient simulator of the electric power grid at a first predetermined grid connection point of the one or more predetermined grid connection points comprises coupling the trained model of the first component to the trained model of the second component at the first predetermined grid connection point.

14. The method of claim 9, comprising:
predicting an electrical response of the first component at the first predetermined grid connection point for a predetermined time range; and
determining, based on the predicted electrical response, controlling instructions for the first component.

15. A system comprising one or more computers and one or more storage devices storing instructions that when executed by the one or more computers cause the one or more computers to perform operations comprising:
obtaining a transient simulator of an electric power grid comprising one or more predetermined grid connection points;
obtaining a trained model of a first component for predetermined operating conditions;
coupling the trained model of the first component to the transient simulator of the electric power grid at a first predetermined grid connection point of the one or more predetermined grid connection points; and
simulating, based on the coupling, a behavior of the first component when connected to the electric power grid at the first predetermined grid connection point.

16. The system of claim 15, wherein the trained model is based on a neural network model.

17. The system of claim 16, wherein the neural network model is a physics-informed neural network model.

18. The system of claim 16, wherein the neural network model is based on a generative adversarial network.

19. The system of claim 15, comprising:
obtaining a trained model of a second component for predetermined operating conditions; and
wherein coupling the trained model of the first component to the transient simulator of the electric power grid at a first predetermined grid connection point of the one or more predetermined grid connection points comprises coupling the trained model of the first component to the trained model of the second component at the first predetermined grid connection point.

20. The system of claim 15, comprising:
predicting an electrical response of the first component at the first predetermined grid connection point for a predetermined time range; and
determining, based on the predicted electrical response, controlling instructions for the first component.
